(19) United States
(12) Patent Application Publication
(10) Pub. No.: US 2006/0073305 A1
(43) Pub. Date: Apr. 6, 2006

(54) Yoga mat

(76) Inventor: Joann S. Kole, Tampa, FL (US)

Correspondence Address: DAVID W. PETTIS, JR., PA, 1210 MILLENIUM PARKWAY, SUITE 2010, BRANDON, FL, 33511-0833, US

(21) Appl. No.: 10/958,135

(22) Filed: Oct. 4, 2004

(51) Int. Cl. B32B 3/02

(52) U.S. Cl. 428/80

(57) ABSTRACT

A yoga mat is provided and includes a plurality of substantially equidistant arms extending radially outwardly from a central segment. This structure permits the practitioner to assume a wide variety of yoga positions (yogasana) without the necessity of repositioning the mat. The mat itself is formed from standard, well known, flexible, resilient materials.

### BACKGROUND OF THE INVENTION

1. Field of the Invention

The present invention relates to a unique mat that is particularly useful for practicing yoga. Of course, it is to be understood that even though this invention is described with particular regard to yoga, it is equally suitable for other forms of exercise. That is to say, in addition to yoga, the mat of this invention is useful whenever one requires a substantially flexible, resilient surface upon which to stand, sit, or lie.

2. Description of the Prior Art

The use of a substantially flexible, resilient mat for purposes of exercise is well known, and such mats are typically formed from a spongy, or rubber-like, substance. Mats of varying shapes and sizes are well known including, for example, the mats used by gymnasts, freestyle and Greco-Roman wrestlers, and even the relatively smaller, usually rectangular mats often used by young children at “nap time” at pre-schools and kindergarten. Many individuals use such mats as part of the equipment for personal exercise and training. Practitioners of yoga almost always practice their positions, or asana, on rectangular mats that are about two feet wide and five feet long.

Because of the material from which they are constructed, state-of-the-art mats are light and are usually stored and transported in a rolled-up condition. The rolled mats are either secured with straps for carrying or placed within a bag. However, these state-of-the-art mats, because of their rather narrow, rectangular shape, require rather frequent repositioning by a practitioner of yoga as he or she transitions from one asana to another.

It is therefore clear that there remains a need in the art of exercise mats and, particularly, yoga mats, for a mat dimensioned and configured such that the practitioner may transition from one asana to another quickly and efficiently. Of course, particularly when practicing in a group setting, the mat must be of a size and shape to provide ample space for a number of mats corresponding to the number of practitioners in the group. Furthermore, such a mat must be of a construction to permit easy storage and transportation by the user.

### SUMMARY OF THE INVENTION

The present invention relates primarily to an improved yoga mat characterized by its construction comprising a central segment and a plurality of substantially equally-spaced arms radiating outwardly from the central segment. According to a preferred embodiment described hereinafter, there are four such arms so that a preferred embodiment for the yoga mat of this invention describes a “plus sign” in a plan view. In addition to being equally spaced around the perimeter of the central segment, each of the arms is of substantially the same length, and each of the arms is of substantially the same width. Transportation and storage of the mat of this invention is easily accomplished by folding opposed arms onto the central segment and then rolling one of the remaining extended arms onto itself, across the central segment and the folded arms, and onto the remaining arm. Releasable means are provided for maintaining the mat in its rolled condition.

It is to be emphasized that while the preferred embodiment of this invention is being described as a yoga mat, that utility is not to be interpreted as a limit on the scope of the present invention. This yoga mat may be used for virtually any form of exercise.

The invention accordingly comprises an article of manufacture possessing the features, properties, and the relation of elements which will be exemplified in the article hereinafter described, and the scope of the invention will be indicated in the claims.

### BRIEF DESCRIPTION OF THE DRAWINGS

For a fuller understanding of the nature and objects of the invention, reference should be had to the following detailed description taken in connection with the accompanying drawings, in which:

FIG. 1 is a top plan view of a preferred embodiment of the yoga mat of this invention.

FIG. 2 is a side elevation of the mat shown in FIG. 1.

FIG. 3 is a bottom plan view of the mat shown in FIG. 1.

FIG. 4 is a perspective view of the mat shown in FIG. 1.

FIG. 5 is a perspective view of the mat shown in FIG. 1, folded and partially rolled.

FIG. 6 is a perspective view of the mat of FIG. 1 in its fully-rolled, storage/transport position.

Similar reference characters refer to similar parts throughout the several views of the drawings.

### DETAILED DESCRIPTION

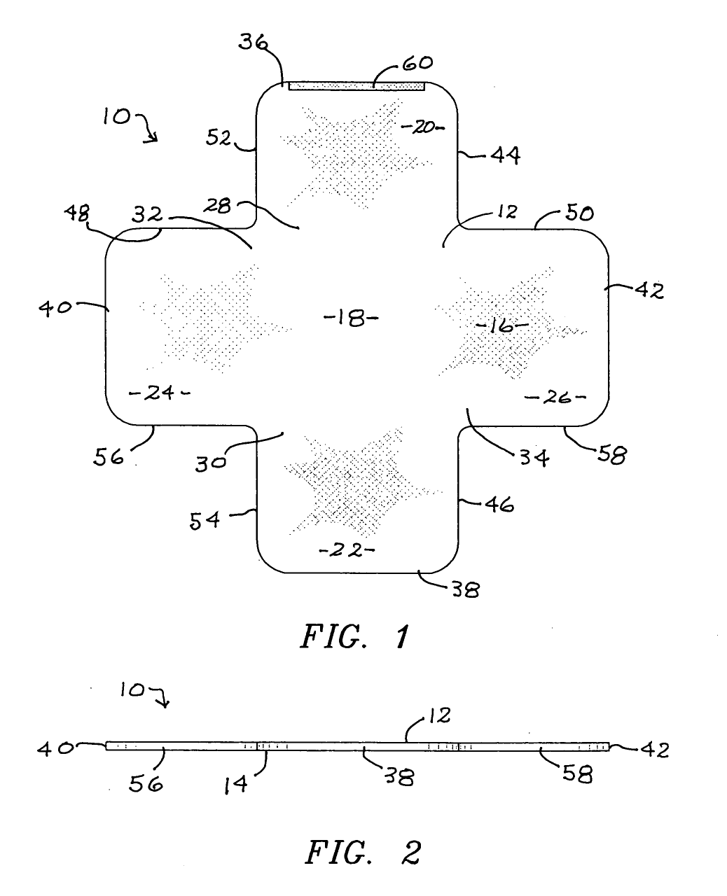

The yoga mat of this invention is generally indicated as 10 in the preferred embodiment illustrated in the views of FIGS. 1-6. Mat 10 is formed from a flexible, resilient material and includes a top surface 12 and an opposed bottom surface 14. Top surface 12 preferably comprises a roughened or textured surface for the benefit of the user, and that roughened or textured surface is indicated by crosshatching 16 in the views of FIGS. 1, 4, and 5. Mat 10 further comprises a central segment 18 and a plurality of arms 20, 22, 24, and 26 extending radially outwardly from central segment 18. Opposed ends of each of the arms 20-26 are defined by respective first ends 28, 30, 32, and 34 and respective second ends 36, 38, 40, and 42.

In accord with this preferred embodiment for yoga mat 10, each of the first ends 28-34 is integral with a corresponding portion of central segment 18. However, it is to be understood that the arms 20-26 could be formed as separate elements with their corresponding first ends 28-34 attached to central segment 18 as by, for example, snaps, hooks, or mating hook and loop fasteners. Such a construction is intended to fall within the scope of the present invention.

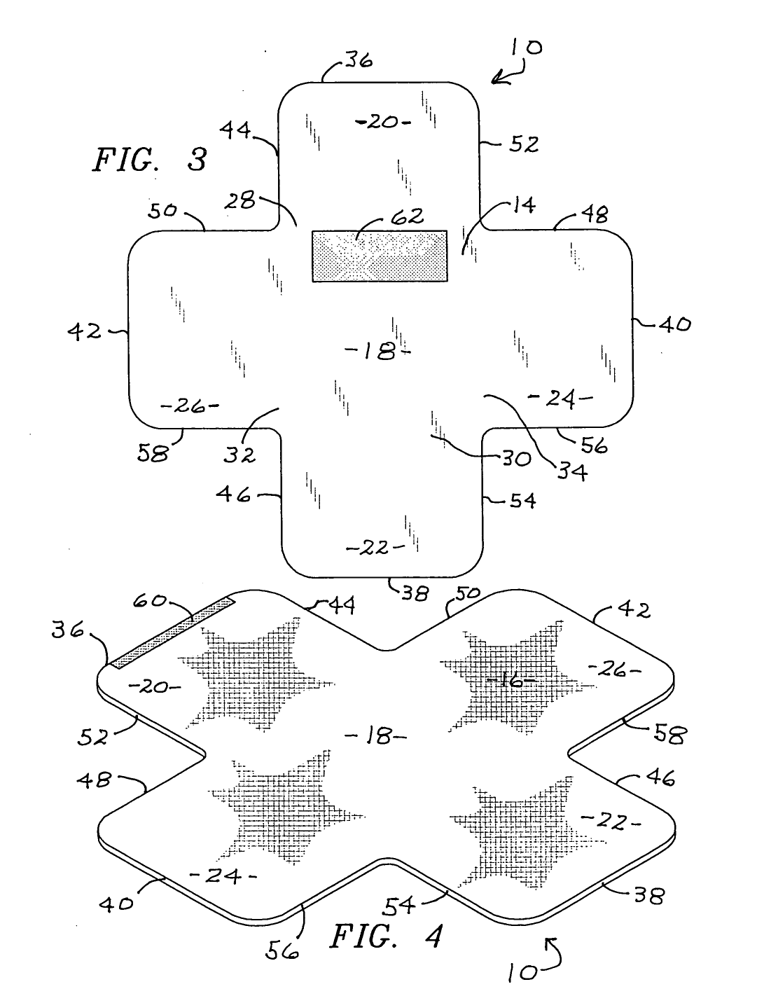

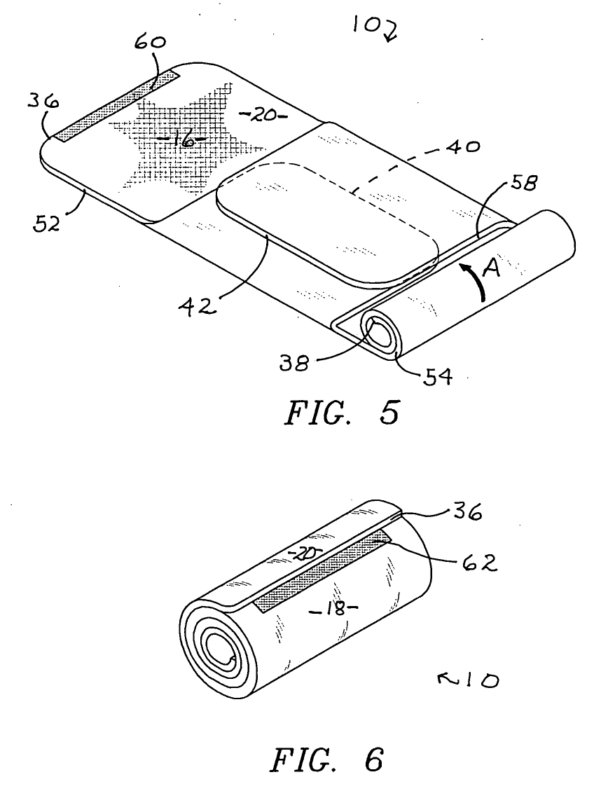

The distance between the first ends 28-34 and the corresponding second ends 36-42 of each of the arms 20-26 defines the arm length. Each of the arms 20-26 further includes a corresponding first side 44, 46, 48, and 50 and a corresponding second side 52, 54, 56, and 58. The distance between each of the first sides 44-50 and the corresponding second sides 52-58 defines the arm width. Referring to the views of FIGS. 1 and 3, it can be seen that yoga mat 10 further comprises a first fastener element 60 disposed on the top surface 12 of arm 20 substantially adjacent second end 36. A second fastener element 62 is disposed on bottom surface 14 of central segment 18 substantially adjacent first end 28. Thus, when yoga mat 10 is folded and rolled, as indicated by directional arrow A in the view of FIG. 5, first fastener element 60 may operatively engage second fastener element 62 to maintain mat 10 in the rolled position indicated in the view of FIG. 6 for storage or transport. In this preferred embodiment for yoga mat 10, first fastener element 60 and second fastener element 62 are mating hook and loop fasteners. However, this is not to be interpreted as a limitation on the scope of the invention, for other releasable fasteners may be used.

Having thus set forth a preferred construction for the yoga mat of this invention, practitioners of yoga will readily appreciate the functionality of yoga mat 10. Depending upon the particular asana of the practitioner, his or her feet may be placed one in front of the other, as in the virasana. In the virasana the left foot would be placed, for example, on arm 20 while the right foot would remain on central segment 18. Then, if the practitioner wished to assume the trikonasana position, his or her feet would be placed with the left foot on arm 24 and the right foot on arm 26. Obviously, then, no repositioning of mat 10 would be required as one moved from one asana to the next.

It will thus be seen that the object set forth above, among those made apparent from the preceding description, are efficiently attained and, since certain changes may be made in the above article without departing from the scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Now that the invention has been described,

What is claimed is:

1. A yoga mat formed from a flexible, resilient material, said mat comprising:
a top surface and an opposed bottom surface, said mat further comprising a central segment and a plurality of arms, each one of said plurality of arms extending radially outwardly from said central segment, each one of said plurality of arms comprising a first end attached to a portion of said central segment, a second end distal from said first end and opposed first and second sides, the distance between said first end and said second end of each one of said plurality of arms defining the arm length and the distance between said first and said second sides of each one of said plurality of arms defining the arm width.

2. A yoga mat as in claim 1, wherein adjacent ones of said plurality of arms define an angle between planes normal to said arm length of said adjacent arms, each one of said angles being substantially equal.

3. A yoga mat as in claim 2, wherein said angle is substantially right.

4. A yoga mat as in claim 2, wherein said arm length of each one of said plurality of arms is substantially equal.

5. A yoga mat as in claim 4, wherein said arm width of each one of said plurality of arms is substantially equal.

6. A yoga mat as in claim 5, wherein said central segment comprises an area, the perimeter of which is defined by said first end of each one of said plurality of arms.

7. A yoga mat as in claim 1, further comprising a first fastener element disposed on said top surface substantially adjacent said distal end of one of said plurality of arms and a second fastener element disposed on said bottom surface substantially adjacent said first end of said one of said plurality of arms.
